(19) United States
(12) Patent Application Publication
(10) Pub. No.: US 2006/0140175 A1
(43) Pub. Date: Jun. 29, 2006

(54) System and method for controlling coupling between communication terminals for audio-video communication

(76) Inventor: Yong-Hee Han, Seongnam-si (KR)

Correspondence Address: Robert E. Bushnell, Suite 300, 1522 K Street, N.W., Washington, DC, 20005-1202, US

(21) Appl. No.: 11/316,998

(22) Filed: Dec. 27, 2005

(30) Foreign Application Priority Data
Dec. 28, 2004 (KR) 10-2004-0114331

(51) Int. Cl. H04L 12/66; H04L 12/56

(52) U.S. Cl. 370/352; 370/401

(57) ABSTRACT

Provided are a system and method for controlling coupling between communication terminals for audio-video communication capable of performing the audio-video communication with a third external communication terminal by interworking a phone screen of a first communication terminal with a WiFi phone of a second communication terminal. The method includes the steps of: setting up, by a first communication terminal having a video communication function and a second communication terminal having an audio communication function, a coupling mode therebetween; and checking a coupling between the first communication terminal and the second communication terminal by means of a coupling identification code, and setting a speech path for transceiving video data to set up the coupling. Thereby, a plurality of WiFi phones are each coupled with one phone screen by predetermined rules, and any one of the WiFi phones can be used as an individual video phone. As such, a degree of application of the phone screen can be improved, and expensive devices mounted in the phone screen can be saved by the number of the coupled WiFi phones.

### CLAIM OF PRIORITY

This application makes reference to, incorporates the same herein, and claims all benefits accruing under 35 U.S.C. §119 from an application for SYSTEM AND METHOD FOR CONTROLLING COUPLING BETWEEN COMMUNICATION TERMINALS FOR AUDIO-VIDEO COMMUNICATION filed in the Korean Intellectual Property Office on Dec. 28, 2004 and there duly assigned Serial No. 10-2004-0114331.

### BACKGROUND OF THE INVENTION

1. Field of the Invention

The present invention relates generally to a system and method for controlling coupling between communication terminals for audio-video communication and, more particularly, to a system and method for controlling coupling between communication terminals for audio-video communication, capable of interworking image technology of a first communication terminal with short-distance wireless communication technology of a second communication terminal to thus perform audio-video communication with a third external communication terminal.

2. Description of the Related Art

Recently, as Internet is widely used, an internet phone is rapidly rising as an almost universalized communication system together with mobile phones, and thus the population taking advantage of the internet phone is increasing exponentially. The internet phone makes it possible to perform communication with any other desired user by use of the communication system interconnected over the Internet. This internet phone arrives up to a technical level enough to perform audio communication as well as video communication while speakers look at faces or appearances of their opposite parties through image transmission allowed by a computer's multimedia function and high-speed communication that is gradually improved. In this manner, the internet phone allowing audio-video communication is especially called a video phone.

This video phone makes it possible to satisfy QoS (Quality of Service) to secure reliability with development of VoIP (Voice over Internet Protocol) technology.

The VoIP (Voice over Internet Protocol) is a term used in IP telephony for a set of facilities for managing the delivery of voice information using the Internet protocol (IP) network. In general, this means sending voice information in digital form in discrete packets rather than in the traditional circuit-committed protocols of the public switched telephone network (PSTN).

VoIP and Internet telephony have a major advantage in that telephone users can be provided long-distance and international call service in Internet and intranet environments by integrating and implementing telephone services over the existing IP network.

VoIP enables the users of a VoIP call to locate other users as well as to use touch-tone signals for automatic call distribution and voice mail in order to promote use of ITU-T (the International Telecommunication Union Telecommunication Standardization Sector) H.323 which is the standard for sending audio and video using the IP on the public Internet or the intranet within the enterprise.

In addition to an original function of the IP, the VoIP makes use of a real-time transport protocol (RTP) to help ensure that packets get delivered in time. The real-time transport protocol (RTP) provides end-to-end delivery services for data with real-time characteristics, such as interactive audio and video or simulation data, over multicast or unicast network services. RTP itself does not provide any mechanism to ensure timely delivery or provide other quality-of-service (QoS) guarantees, but relies on lower-layer services to do so. Public networks make it difficult as yet to guarantee QoS, but private networks managed by an independent enterprises or Internet telephony service providers (ITSP) make it possible to provide better service.

Recently, the Internet phone has shown a tendency toward development of a mobile phone system of grafting the VoIP technology and WLAN (Wireless Local Area Network) technology for the purpose of implementation of one phone per individual and an ever-portable phone. As an example of a communication terminal employing the VoIP and WLAN technologies, there is a WiFi (short for “wireless fidelity”) phone. Further, there are developed various short-distance wireless communication technologies such as Zigbee, UWB (Ultra WideBand), Bluetooth etc. inclusive of the WLAN. Here, the communication terminals such as WiFi, Zigbee, UWB and Bluetooth phones will be called short-distance wireless communication terminals.

The video phones that the public can use at an inexpensive cost on the basis of this VoIP technology are being developed. However, in spite of its characteristic capable of communicating with the opposite party while looking at his/her face, the video phone does not have the same mobility as a mobile phone. As such, it should be apparent that the video phone shows a considerable limit to generalization.

Further, the video phone has to input a phone number of the opposite party whenever communication is required like the general line telephone. Hence, a number of users have difficulty in sharing the expensive video phone as they use their own phones.

Although the video phone gets rid of such difficulty and mobility, various elements equipped with the video phone, such as a camera, an LCD (Liquid Crystal Display), a protocol stack for the VoIP (H.323, SIP etc.), a high-performance CPU (Central Processing Unit) for implementing complicated functions, a mass memory and so forth, are still expensive. For this reason, the video phone has many difficulties in popularization.

Thus, many attempts have been made to popularize the vide phone, but the video phone leaves many problems to be overcome for realization. As such, the video phone fails to produce visual results.

### SUMMARY OF THE INVENTION

It is, therefore, an objective of the present invention to provide a system and method for coupling between communication terminals for audio-video communication, in which each second communication terminal realizing short-distance wireless communication technology is coupled as a terminal of constant rules with a first communication terminal realizing image technology and thus used as one integrated video phone, thereby being capable of communicating with a third communication terminal realizing audio-video communication technology.

It is another objective of the present invention to provide a system and method for coupling between communication terminals for audio-video communication, in which a second communication terminal makes exclusive use of an image screen of a first communication terminal by simultaneously coupling the first and second communication terminals by constant rules, as well as the plurality of second communication terminals share one first communication terminal, thereby maximizing a degree of application of image technology.

In order to accomplish these objectives, according to an aspect of the present invention, there is provided a system for controlling coupling between communication terminals for audio-video communication with a third communication terminal having video and audio communication functions. The system comprises: a first communication terminal that performs reciprocal recognition with a second communication terminal on the basis of a wired and wireless local area network (LAN), establishes a first speech path for video communication with a third communication terminal to set up a coupling with a second communication terminal, and performs video communication with the third communication terminal using the first speech path; and the second communication terminal that performs reciprocal recognition with the first communication terminal on the basis of the wired and wireless LAN, establishes a second speech path for audio communication with the third communication terminal to set up a coupling, performs audio communication with the third communication terminal using the second speech path, and sends a lip-sync packet to the first communication terminal.

The first communication terminal may include: an Ethernet interface that interfaces with the second communication terminal on the basis of the wired and wireless LAN to transceive coupling information for setting up the coupling, and performs video real time protocol (RTP) communication with the third communication terminal through the first speech path; a video codec that performs signaling on compression data of a video RTP to be displayed on a monitor and compresses a video signal of a camera at a predetermined rate of compression; a flash memory that stores the coupling information and information on the first speech path for establishing the first speech path; and a central processing unit (CPU) that controls the Ethernet interface, the video codec and the flash memory so as to enable the coupling with the second communication terminal and the communication with the third communication terminal.

Further, the second communication terminal may include: a wireless local area network (WLAN) that interfaces with the first communication terminal on the basis of the wired and wireless LAN to transceive coupling information for setting up the coupling, and performs audio real time protocol (RTP) communication with the third communication terminal through the second speech path; an audio codec that reproducibly performs audio signaling on an audio RTP to be audibly heard at a handset, and coverts an audio signal of the handset into an RTP signal; a flash memory that stores the coupling information and information on the second speech path for establishing the second speech path; and a central processing unit (CPU) that controls the WLAN, the video codec and the flash memory so as to enable the coupling with the second communication terminal and the communication with the third communication terminal. The WLAN may connect the first communication terminal with the third communication terminal on the basis of a wired LAN via an access point (AP) when the WLAN is a wireless network.

Furthermore, the first speech path information may include IP information of the first communication terminal for transceiving the video signal, and media port and codec information for transceiving the video signal. The second speech path information may include IP information of the second communication terminal for transceiving the audio signal, and media port and codec information for transceiving the audio signal. The coupling information may include an identification code for recognizing reciprocal coupling between the first communication terminal and the second communication terminal, and an identification code of the first communication terminal. The first communication terminal may be any one of a phone screen having a wireless video communication function, and a personal computer (PC) having a wireless video communication function. The second communication terminal may be a short-distance wireless communication terminal having a wireless audio communication function.

According to another aspect of the present invention, there is provided a system for controlling coupling between communication terminals for audio-video communication with a third communication terminal having video and audio communication functions. The system comprises: a first communication terminal that performs reciprocal recognition with a second communication terminal on the basis of a wired and wireless local area network (LAN), establishes a first speech path for the video communication with the second communication terminal to set up a coupling, and performs communication of video signal and lip-sync packet from the second communication terminal through the first speech path; and a second communication terminal that performs reciprocal recognition with a first communication terminal on the basis of the wired and wireless LAN, establishes a second speech path for audio-video communication with the third communication terminal to set up a coupling, performs any one of video communication and audio communication with the third communication terminal using the second speech path, and selectively performs communication of video signal and lip-sync packet on the first communication terminal.

According to yet another aspect of the present invention, there is provided a method for controlling coupling between communication terminals for audio-video communication. The method comprises the steps of: setting up, by a first communication terminal having a video communication function and a second communication terminal having an audio communication function, a coupling mode therebetween; and checking a coupling between the first communication terminal and the second communication terminal by means of a coupling identification code, and setting a speech path for transceiving video data to set up the coupling.

The step of setting up the coupling may include the steps of: broadcasting a first packet to the second communication terminal, the first packet having an identification code of the first communication terminal and the coupling identification code of the second communication terminal corresponding to the identification code; sending, by the second communication terminal receiving the first packet, the coupling identification code and a second packet to the first communication terminal to check a coupled terminal, the second packet having a media access control (MAC) address of the second communication terminal; determining whether or not the coupling identification code of the second packet sent from the second communication terminal is matched with that of the first packet broadcast from the first communication terminal; recognizing the second communication terminal as the coupled terminal of the first communication terminal to add the second communication terminal to a coupling list on the basis of the determining, and storing the MAC address of the second communication terminal in a memory of the first communication terminal; sending a third packet having information on the speech path of the first communication terminal to the second communication terminal after the MAC address is stored; and storing an MAC address of the third packet in a memory of the second communication terminal, and sending a fourth packet for acknowledging the third packet to the first communication terminal to complete the coupling.

The method may further include the step of processing at least one of video and audio calls between the coupled terminal and the other party, the third communication terminal, on the basis of the speech path information.

The step of processing at least one of video and audio calls may include the steps of: generating, at the second communication terminal, a Call Start packet to the first communication terminal; determining, at the first communication terminal, whether the speech path is in use or not; sending a Call Start Nack packet to the second communication terminal when the speech path is in use, and sending a Call Start Ack packet to the second communication terminal when the speech path is not in use; establishing, by the second communication terminal itself, the speech path based on information on the speech path, sending a call processing packet having the speech path information to the first communication terminal, and opening the speech path by returning the call processing packet to the second communication terminal; receiving an audio real time protocol (RTP) from the third communication terminal on the basis of a VoIP-based audio speech path, generating a lip-sync packet from the audio RTP, and sending the lip-sync packet to the first communication terminal; receiving a video RTP from the third communication terminal on the basis of a VoIP-based video speech path and displaying the video RTP by interworking (the term implies that there is some difference between the components which, in the absence of common standards, would make it unlikely that they could be used together) with the lip-sync packet; sending, to the third communication terminal, the video RTP compressing a video signal from a camera of the first communication terminal and the audio RTP compressing an audio signal from the second communication terminal through the corresponding speech paths; repeating the steps until a call disconnect message is received from the second communication terminal; stopping transmission of the lip-sync packet according to an instruction of disconnecting the call generated from the second communication terminal, closing the corresponding speech path to send a call termination packet to the first communication terminal; and stopping transmission of the video packet according to the call termination packet, closing the speech path to send an acknowledgement packet of the call termination packet to the second communication terminal.

According to still another aspect of the present invention, there is provided a method for controlling coupling between communication terminals for audio-video communication. The method comprises the steps of: while a second communication terminal having an audio communication function is coupled with a first communication terminal having a video communication function in a started state, starting the first communication terminal by supplying the first communication terminal with power again; and checking from the first communication terminal started in the step of starting whether to be coupled with the second communication terminal, and restoring a coupling between the first and second communication terminals.

The step of restoring the coupling may include the steps of: broadcasting a first packet having an identification code of the first communication terminal to the second communication terminal; extracting a media access control (MAC) address of the first communication terminal from the first packet, checking whether or not the extracted MAC address is matched with that stored in the second communication terminal, and sending a second packet for coupling acknowledgment to the first communication terminal; extracting an MAC address of a sender from the second packet, checking setting according to whether or not the extracted MAC address is matched with that recorded in a coupling list of the first communication terminal; sending a third packet having speech path information of the first communication terminal to the sender after the second packet is received; and sending a fourth packet for acknowledging the third packet to the first communication terminal to complete the coupling.

The method may further include the step of: when another second communication terminal exists in the coupling list, repeating the steps of checking setting of the MAC address and restoring the coupling.

Further, the method may further include the step of processing at least one of video and audio calls between a coupled terminal and the other party, the third communication terminal, on the basis of restored speech path information.

According to still yet another aspect of the present invention, there is provided a method for controlling coupling between communication terminals for audio-video communication. The method comprises the steps of: while a first communication terminal having a video communication function is coupled with a second communication terminal having an audio communication function in a started state, starting the second communication terminal by supplying the second communication terminal with power again; and checking from the second communication terminal started in the step of starting whether to be coupled with the first communication terminal, and restoring a coupling between the first and second communication terminals.

The step of restoring the coupling may include the steps of: checking that a media access control (MAC) address of the first communication terminal is stored in the second communication terminal, and sending a first packet, Re-coupling packet, for restoring a disconnected coupling to the first communication terminal; receiving the first packet, checking that the same MAC address as that of the second communication terminal or sender is stored in the coupling list of the first communication terminal, and sending a second packet, Introduce-Me packet, to the second communication terminal, the second packet having an identification code of the first communication terminal; extracting the MAC address of the second communication terminal or sender from the second packet of the first communication terminal, checking whether or not the extracted MAC address is identical to that of the second communication terminal, sending a third packet requesting the coupling to the first communication terminal; sending a fourth packet to the sender after the third packet is received, the fourth packet having speech path information of the first communication terminal; and sending a fifth packet for acknowledging the fourth packet to the first communication terminal and restoring the coupling.

Further, the method may further include the step of processing a call by sequentially performing call connection, audio/video communication, and call disconnection between a coupled terminal and the other party, the third communication terminal, on the basis of restored speech path information.

According to still yet another aspect of the present invention, there is provided a method for controlling coupling between communication terminals for audio-video communication. The method comprises the steps of: setting up, by a first communication terminal having a video communication function itself, a video recognition coupling mode, and setting up, by a second communication terminal having an audio communication function itself, the video recognition coupling mode; and reading, by the first communication terminal, a recognition code where a media access control (MAC) address of the second communication terminal is coded at a liquid crystal display (LCD) window of the second communication terminal, and thus setting coupling and speech path information between the first communication terminal and the second communication terminal to set up a coupling.

The step of setting up the coupling may include the steps of: sending a first packet, Introduce-Me packet, through the MAC address of the second communication terminal, the first packet having identification code of the first communication terminal and coupling identification code; sending, by the second communication terminal receiving the first packet, a second packet to the first communication terminal, the second packet having the coupling identification code and the MAC address of the second communication terminal; determining whether or not the coupling identification code of the second packet is matched with that of the first packet sent from the first communication terminal; recognizing a sender of the first communication terminal as a coupled terminal of the first communication terminal on the basis of the determining, adding the sender to a coupling list, and storing the MAC address of the second communication terminal in a memory of the first communication terminal; sending a third packet to the sender after the MAC address is stored, the third packet having the speech path information of the first communication terminal; and storing the MAC address of the first communication terminal in a memory of the sender from the third packet, and sending a fourth packet for acknowledging the third packet to the first communication terminal to complete the coupling.

Further, the method may further include the step of processing at least one of video and audio calls between the coupled terminal and the other party, the third communication terminal, on the basis of set speech path information.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 shows a general video phone;

FIG. 2 shows one embodiment of the present invention in which a phone screen and a WiFi phone are adopted as first and second communication terminals, respectively;

FIG. 3 shows another embodiment of the present invention in which a phone screen or PC, and a WiFi phone or wired IP phone are adopted as first and second communication terminals, respectively;

FIG. 4A is a block diagram illustrating in detail an embodiment of a first communication terminal (phone screen) in accordance with the present invention;

FIG. 4B is a block diagram showing an embodiment of a second communication terminal (WiFi phone) in detail according to the present invention;

FIG. 5 is a flowchart for carrying out coupling between first and second communication terminals by user's request in accordance with the present invention;

FIG. 6 is a flowchart where first and second communication terminals according to the present invention are coupled to perform audio-video communication with a third communication terminal in accordance with the present invention;

FIG. 7 is a flowchart of restoring coupling between first and second communication terminals by power supply of the first communication terminal in accordance with the present invention;

FIG. 8 is a flowchart of restoring coupling between first and second communication terminals by power supply of the second communication terminal in accordance with the present invention; and

FIG. 9 is a flowchart of carrying out coupling between first and second communication terminals by means of an identification code of the first communication terminal in accordance with the present invention.

### DETAILED DESCRIPTION OF THE INVENTION

Hereinafter, a system and method for controlling coupling between communication terminals for audio-video communication in accordance with the present invention will be described in detail with reference to the accompanying drawings.

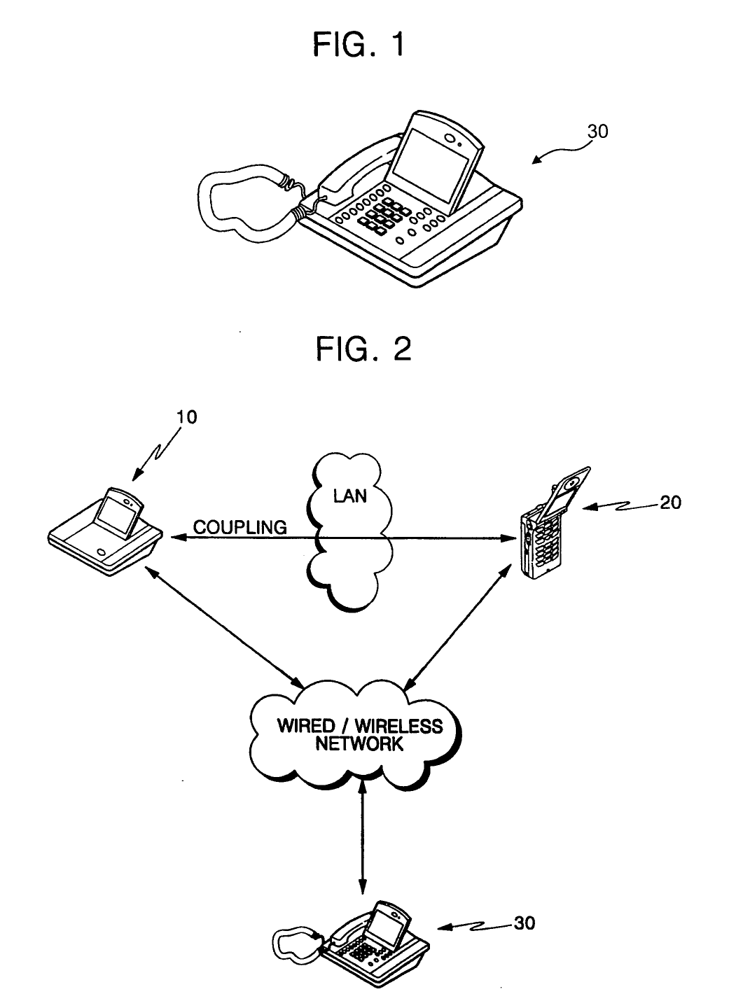

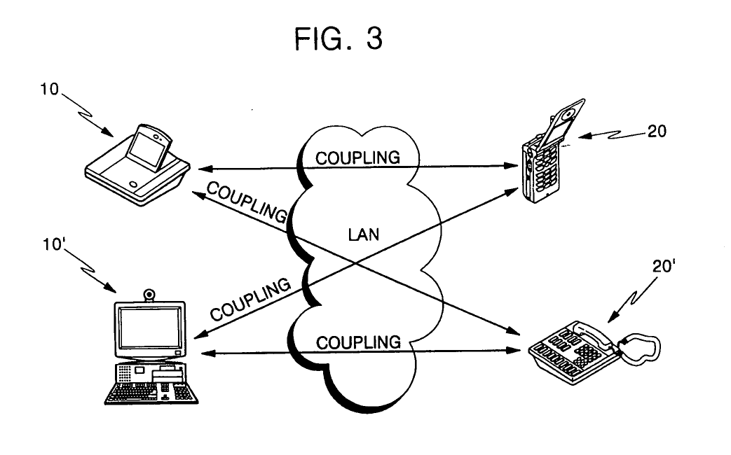

FIG. 1 shows a general video phone 30. FIG. 2 shows one embodiment of the present invention in which a phone screen 10 and a WiFi phone 20 are adopted as first and second communication terminals, respectively.

The first communication terminal implementing image technology includes a camera and a liquid crystal display (LCD) monitor, and performs video communication with a general video phone (third communication terminal) 30 over a LAN and a WAN (Wide Area Network). The second communication terminal 20 implementing short-distance wireless communication technology performs audio communication with the third communication terminal 30 over LAN and WAN.

As in the embodiment shown in FIG. 2, the first and second communication terminals are implemented as a phone screen 10, and a WiFi phone 20, respectively. Herein, the “video communication” refers to communication for transmitting an image in a video communication, and the “audio communication” refers to communication for transmitting voice and sound in an audio communication.

The first and second communication terminals 10 and 20 of the present invention complete reciprocal coupling on the basis of wireless or wired LAN, and perform audio-video communication with the third communication terminal 30, e.g., the video phone, in an integrated state.

The present invention performing the audio-video communication with the third communication terminal 30 through the coupling of the first communication terminal 10 and the second communication terminal 20 can be divided into two types: coupling division communication and coupling integration communication according to a communication mode.

The coupling division communication is a system where the first and second communication terminals 10 and 20 individually perform the video communication and the audio communication, while the coupling integration communication is a system where the second communication terminal 20 performs the video communication and the audio communication simultaneously. In the coupling integration communication, the first communication terminal 10 takes charge of image processing alone.

First, the coupling division communication will be described.

In the coupling division communication, the first communication terminal 10 takes exclusive charge of the video communication with the third communication terminal 30, and the second communication terminal 20 takes exclusive charge of the audio communication with the third communication terminal 30. At this time, the second communication terminal 20 sends a lip-sync packet for providing synchronization of video and audio to the first communication terminal 10. The lip-sync packet allows integrated audio-video communication without a time difference between the video communication and the audio communication.

Next, the coupling integration communication will be described.

In the coupling integration communication, the second communication terminal 20 performs the video communication and the audio communication with the third communication terminal 30 at the same time. Here, the second communication terminal 20 causes image processing for the video communication with the third communication terminal 30 to be performed at the first communication terminal 10. To be specific, the second communication terminal 20 transmits data for the video communication, which are received from the first communication terminal 10 and processed by image processing technology of the first communication terminal 10, to the third communication terminal 30, and outputs data for the video communication, received from the third communication terminal 30, to the first communication terminal 10. Thereby, the first communication terminal 10 performs the image processing of the data. Further, the second communication terminal 20 transmits a lip-sync packet, which is for synchronizing audio processed at the second communication terminal 20 and video processed at the first communication terminal 10, to the first communication terminal 10, thereby synchronizing the audio and the video.

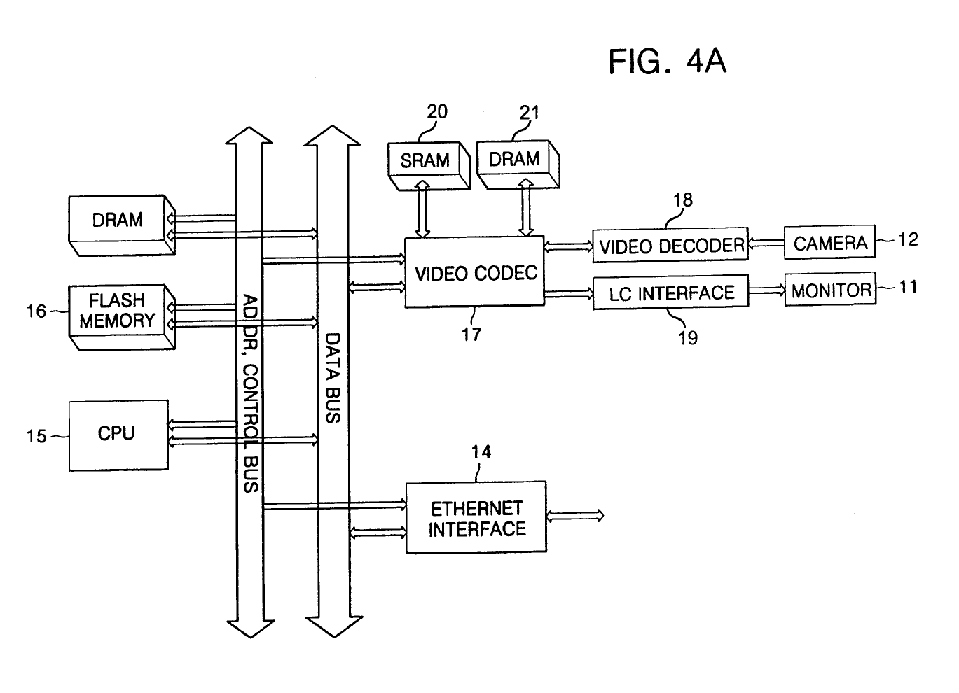

FIG. 3 shows another embodiment where a phone screen 10 or personal computer (PC) 10′ is adopted as a first communication terminal and a WiFi phone 20 or wired IP phone 20′ is adopted as a second communication terminal.

A first communication terminal 10 may be implemented as a phone screen 10, a PC 10′ performing the same function as the phone screen 10, a multimedia instrument (not shown) having a function similar to the phone screen, and so on. The phone screen 10, PC 10′, multimedia instrument etc. can be coupled with the second communication terminal 20 on the basis of the wireless or wired LAN. Further, the second communication terminal 20 may include a WiFi phone 20 as mentioned above, an IP phone 20′ that can perform communication on the basis of the IP, or a phone (not shown) having a function similar to them.

First, as an exemplary embodiment of the present invention, assuming that the first communication terminal is the phone screen 10 and that the second communication terminal is the WiFi phone 20, it is considered that the coupling between the two communication terminals is carried out on the basis of the wireless/wired LAN.

When the two communication terminals communicates with a third communication terminal according to the coupling division communication, the phone screen 10 performs RTP video communication with the third communication terminal in a coupling state on the basis of the wireless networking, and the WiFi phone 20 performs RTP audio communication with the third communication terminal on the basis of the wireless networking. Meanwhile, when the two communication terminals communicates with the third communication terminal according to the coupling integration communication, the WiFi phone 20 simultaneously performs the RTP audio communication and the RTP video communication with the third communication terminal 30, and performs the RTP video communication with the phone screen 10.

Here, the WiFi phone 20 can be coupled with the phone screen 10 through an access point (AP) on the basis of the wireless LAN. Of course, the WiFi phone 20 may be directly coupled with the AP by use of short-distance wireless communication technology other than the wireless LAN. In this manner, for the purpose of the coupling through the wireless LAN, the WiFi phone 20 and the phone screen 10 should be based on the same interface. It should be noted that the present invention will be described below about the embodiment not only on the basis of the LAN but also on the basis of communication technology other than the LAN.

In addition, assuming that that the second communication terminal is the IP phone 20′, the phone screen 10 and the IP phone 20′ can coupled on the basis of the wired LAN. Thereafter, the two communication terminals perform the RTP video and audio communication with the third communication terminal in any one of the coupling division and integration communications on the basis of the wired LAN.

Hereinafter, an embodiment will be described with reference to the attached drawings under the assumption that the first and second communication terminals 10 and 20 are the phone screen 10 and the WiFi phone 20 respectively, and perform audio-video communication with the third communication terminal 30 through the coupling division communication.

A phone screen 10 is coupled with a WiFi phone 20 on the basis of the LAN to interwork with it according to the lip-sync, and performs video communication for audio-video communication with a third communication terminal, a video phone, 30 through the coupling division communication.

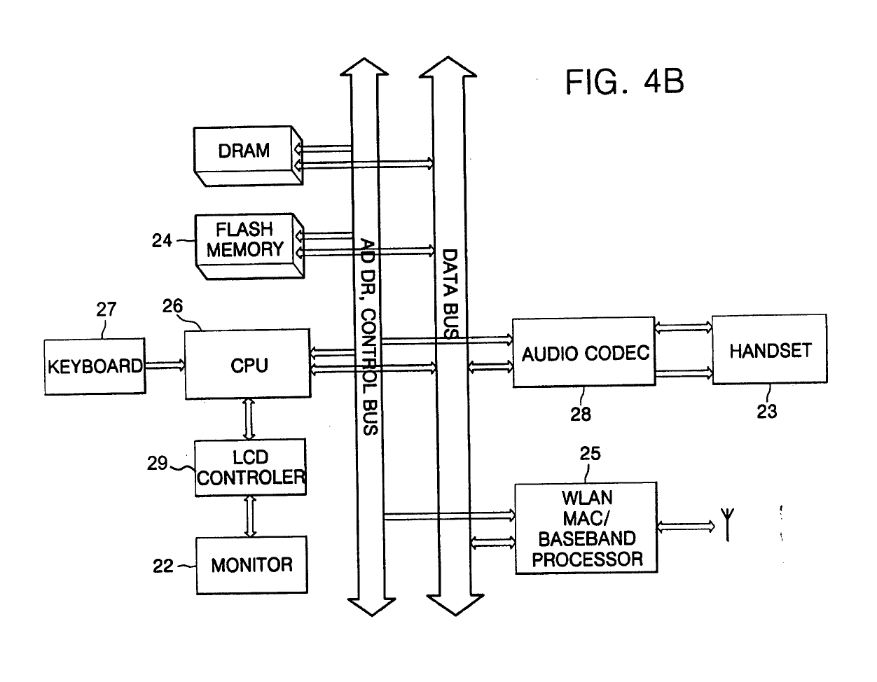

FIG. 4A is a block diagram illustrating in detail an embodiment of a phone screen in accordance with the present invention and will be described below with reference to FIGS. 2 and 3.

In general, the phone screen is structurally located adjacent to a monitor 11 and a camera 12. After being coupled, the monitor 11 and the camera 12 can perform video communication with the third communication terminal 30. The phone screen 10 has reciprocal recognition with the WiFi phone 20 on the basis of the wired/wireless LAN. Then, the phone screen 10 establishes a speech path capable of communicating with the third communication terminal 30 to set up a coupling, and performs VoIP-based video communication with the third communication terminal 30 through the speech path. Here, the reciprocal recognition between the phone screen 10 and the WiFi phone 20 corresponds to a preparation process for a future coupling setup. Hereinafter, the preparation process for the coupling setup is referred to as “process for a coupling mode setup.”

The phone screen 10 and the WiFi phone 20, which are set up in the coupling mode establish the speech path with the third communication terminal 30 through a process for the future coupling setup, and perform the audio-video communication with the third communication terminal 30 using the established speech path.

Meanwhile, a plurality of second communication terminals may simultaneously undergo the coupling mode setup with the first communication terminal 10. In this manner, the second communication terminals that undergo the coupling mode setup with the first communication terminal 10 establish the speech path through the coupling setup at any time to perform the audio-video communication with the third communication terminal 30. However, since all of the plurality of second communication terminals 20 have difficulty in simultaneously performing the audio-video communication using the first communication terminal 10, only one selected from the second communication terminals 20 that undergo the coupling mode setup according to a predetermined rule is generally set up to perform the audio-video communication using the first communication terminal 10. At this time, the second communication terminal 20 taking priority of the first communication terminal 10 is generally set up to perform the audio-video communication using the first communication terminal 10.

Here, information used for the coupling mode setup between the phone screen 10 and the WiFi phone 20 is referred to as “coupling information,” and information used for establishing the speech path for performing the audio-video communication with the third communication terminal 30 is referred to as “speech path information.” The coupling information may include an identification code for recognizing a reciprocal coupling between the phone screen 10 and the WiFi phone 20, and an identification code for the phone screen 10. The speech path information may include IP information of the phone screen 10 or WiFi phone 20, media port information for video or audio data transmission, and codec information for data processing.

In order to perform video communication with the third communication terminal 30, the phone screen 10 essentially includes a wired and wireless Ethernet interface 14 that transceives the coupling information for setting the coupling with the WiFi phone 20 on the basis of the wired and wireless LAN and performs RTP video communication through the speech path for performing the video communication with the third communication terminal 30 on the basis of the VoIP, a video codec 17 that performs signal processing on compressed video data of a video RTP to be displayed on the monitor 11 and compresses a video signal of the camera 12 at a predetermined rate, a flash memory 16 that stores the coupling information and speech path information of the wired and wireless Ethernet interface 14, and a CPU 15 that controls the video codec 17, the flash memory 16 and the wired and wireless Ethernet interface 14 in order to enable the coupling with the WiFi phone 20 and the communication with the third communication terminal 30.

A video decoder 18 interposed between the camera 12 and the video codec 17 converts a pickup signal of the camera 12 into a video signal to be suitable for the codec information that has been set up. An LC interface 19 interposed between the monitor 11 and the video codec 17 provides a video reproduction signal to the video codec 17 by interfacing with the monitor 11. Further, SRAM (Static Random Access Memory) 20 and DRAM (Dynamic Random Access Memory) 21 store either an algorithm required for the video codec or system information, whose reference numbers are not indicated.

The speech path, as a video transmission channel, is established by a media port for transceiving IP address information and video signal of the phone screen 10. It is the coupling division communication that uses the media port for transceiving the IP address information and video signal of the phone screen 10 in order to establish the speech path for the video communication with the third communication terminal 30. In contrast, in the coupling integration communication, the speech path is established by the media port for transceiving IP information of the WiFi phone 20 and only the video signal of the third communication terminal 30, from the WiFi phone 20 to the phone screen 10 and vice versa.

Here, the phone screen 10 may be replaced by a PC 10′ having a wireless video communication function. In that case, the PC 10′ can be coupled with the WiFi phone 20 on the basis of the wired and wireless LAN.

FIG. 4B is a block diagram showing an embodiment of a WiFi phone in detail according to the present invention and will be described below with reference to FIGS. 2 and 3.

As to a configuration of a WiFi phone 20, it is coupled with a phone screen 10 on the basis of the wired and wireless LAN, interworked with the phone screen 10 according to lip-sync, and performs audio communication for audio-video communication with a third communication terminal, or a video phone, 30.

In general, a keyboard 27, a monitor 22 and a handset 23 of the WiFi phone 20 are structurally adjacent to each other. The WiFi phone 20 performs reciprocal recognition with the phone screen 10 on the basis of the wired and wireless LAN. Then, the WiFi phone 20 establishes a speech path to set up a coupling. The speech path is used for the audio communiation with the third communication terminal 30. The WiFi phone 20 performs VoIP based audio communication with the third communication terminal 30 through the speech path.

In order to perform audio communication with the third communication terminal 30, the WiFi phone 20 is essentially composed of a WLAN (Wireless LAN) 25 that transceives coupling information for setting the coupling with the phone screen 10 on the basis of the wired and wireless LAN and performs RTP audio communication with the third communication terminal 30 through the speech path on the basis of the VoIP, an audio codec 28 that performs reproducible audio signal processing on compressed audio data of an audio RTP so as to be audible through the handset and compresses an audio signal of the handset 23 at a predetermined rate, a flash memory 24 that stores the coupling and speech path information received from the WLAN 25, and a CPU 26 that controls the WLAN 25, the audio codec 28 and the flash memory 24 in order to enable the coupling with the phone screen 10 and the communication with the third communication terminal 30.

An LCD controller 29 is for reproducing characters, figures etc. of the keyboard 27.

Herein, the WiFi phone 20 may be replaced by an IP phone 20′ having a wireless audio communication function. In that case, the present invention maybe applied to the IP phone 20′ and the phone screen 10 as mentioned above. However, when the IP phone 20′ is used as the second communication terminal 20, the IP phone 20′ and the phone screen 10 can be coupled on the basis of the wired LAN.

The following description will be made regarding a method for controlling coupling between communication terminals for audio-video communication, in which, as set forth above, the first and second communication terminals set up the coupling to perform the audio-video communication.

In this method, the first communication terminal 10 having a video communication function and the second communication terminal 20 having an audio communication function set up a coupling by performing a coupling mode setup for themselves in order to prepare the audio-video communication where reciprocal audios and videos are maintained in lip-sync, and setting both coupling information for integration between the first and second communication terminals 10 and 20 and speech path information for performing the audio-video communication with the third communication terminal 30.

And when the communication is requested or attempted with the coupling set up, call connection, audio/video communication and call disconnection are sequentially performed between a coupled terminal and the other party, i.e. the third communication terminal 30, on the basis of the speech path information, and thereby call processing is performed with effect. Here, the coupling mode setup is for a user manipulating operation buttons of the first and second communication terminals 10 and 20 to allow the communication terminals to make a coupling environment for integration for themselves.

To make description in more detail, for the sake of convenience, the first communication terminal 10 is called the phone screen 10, and the second communication terminal 20 is called the WiFi phone 20.

The phone screen 10 and the WiFi phone 20 perform the coupling mode setup for themselves in such a manner that the user converts a current mode of the portable WiFi phone 20 into a coupling mode to thereby open a coupling module of the WiFi phone 20, and then converts the coupling mode of the phone screen 10 which is rested at a predetermined position to open the coupling module of the phone screen 10.

The phone screen 10 and the WiFi phone 20 are coupled by setting both the coupling information for integrating the phone screen 10 with the WiFi phone 20 on the basis of the wired and wireless LAN, and the speech path information for performing the audio-video communication with the third communication terminal 30, thereby performing a function similar to a single video phone. Here, the speech path information is sent to media channels, namely corresponding IP information and media port, for the video communication and audio communication respectively, and synchronized to perform integrated operation.

At this time, the phone screen 10 and the WiFi phone 20 are coupled into a single video phone, thus performing the integrated operation like a single phone. As such, for the sake of convenience, the phone screen 10 and the WiFi phone 20 are each called a coupling video phone. The third communication terminal 30 as the video phone is the other video phone communicating with the coupling video phone. For the sake of convenience, the third communication terminal 30 is called a receiving video phone 30.

When the speech path is opened, the coupling video phones 10 and 20 can initiate communication with the receiving video phone 30. The coupling video phones 10 and 20 check the coupling therebetween and prepare call connection with the receiving video phone 30 through a wired and wireless network. Then, the coupling video phones 10 and 20 complete the call connection, so that the video communication and the audio communication are performed by the phone screen 10 and the WiFi phone 20, respectively. Therefore, integrated audio-video communication is allowed. When the audio-video communication is completed, the call connection for the audio communication is released, and then the call connection for the video communication is also released.

The above-mentioned coupling will be described in more detail, which is intended for the integrated operation of the phone screen 10 and WiFi phone 20, the coupling video phones, of the present invention. When an owner of the WiFi phone 20 makes a request for the coupling, the method for controlling the coupling between the communication terminals is as follows.

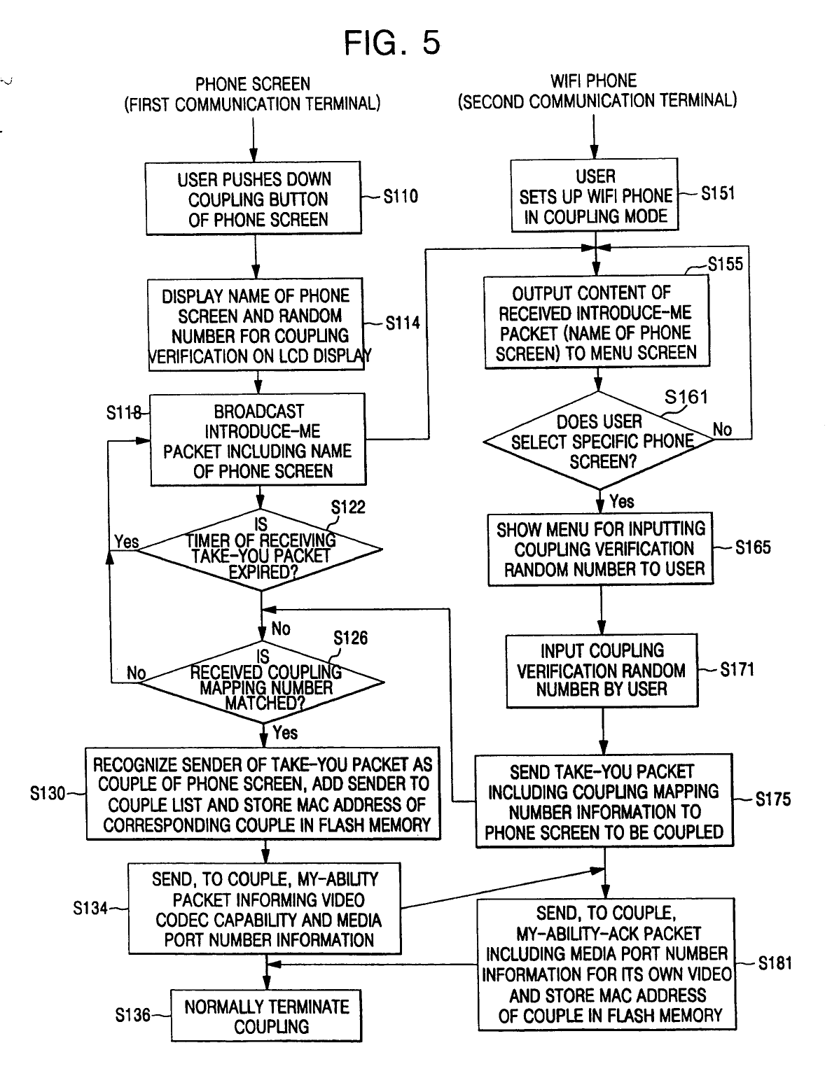

FIG. 5 is a flowchart for carrying out coupling between first and second communication terminals by user's request in accordance with the present invention.

First, it is assumed that a plurality of portable WiFi phones 20 have already completed the coupling with a phone screen 10. A user, who owns both the WiFi phone 20 and the phone screen 10 to perform video-audio communication, sets the WiFi phone 20 to a coupling mode, and then requests the coupling for the video-audio communication by means of the portable WiFi phone (S151). Further, the user manipulates any one of operational buttons of the phone screen 10 so as to carry out the coupling mode, so that the operational button is switched to initiate the coupling mode between the two communication terminals (S110). At this time, the phone screen 10 performs a coupling algorithm to be coupled with the WiFi phone 20, as follows.

The phone screen 10 displays, on its monitor (LCD window), two identification codes: one for its own name (referred to as “name identification code”) and the other for verification of the coupling (random number, and referred to as “coupling identification code”) (S114), so that the identification codes of the phone screen 10 are subjected to visual checking of the user. Here, the name identification code is made up of characters, and the coupling identification code is made up of at least one of characters, numbers and symbols. Therefore, the name identification code may be represented literally by the name denominating the phone screen, and the coupling identification code may be represented by, for example, 23456, ERT1234, $$% ERT123 and so on.

The phone screen 10 broadcasts, to the WiFi phones 20, an Introduce-Me packet (hereinafter, referred to as “first packet”) including these identification codes, thereby detecting the WiFi phone 20 to be coupled (S118). The WiFi phone 20 to be coupled receives the first packet including the identification codes in a state where its equipment environment is set to the coupling mode, and displays the identification codes included in the first packet on the menu screen of its LCD window or monitor, thereby informing the user of the identification codes (S155).

The user checks the name of the phone screen 10 displayed on the menu screen of the monitor of the WiFi phone 20, and then selects the phone screen 10 whose name is checked (S161). Thus, the WiFi phone 20 requests the user to input the coupling identification code (random number) for coupling verification (S165). Here, the user inputs the coupling identification code (random number) that is intended for transmission together with the name of the phone screen 10 (S171). Then, the WiFi phone 20 returns a Take-You packet (hereinafter, referred to as “second packet”) including the coupling identification code (random number for the coupling verification) to the phone screen 10 (S175). Here, the second packet includes an MAC address of the WiFi phone 20 inclusive of the coupling identification code. Hence, this information may be extracted from the second packet.

Before response timing when the second packet is received expires (S122), the phone screen 10 receives the coupling identification code of the second packet, and determines whether the coupling identification code of the second packet is identical to that of the first packet which the phone screen 10 has sent to the WiFi phone (S126). As a result, the two identification codes are identical to each other, the phone screen 10 recognizes the WiFi phone 20 as a sender of the second packet, thus adding a terminal having the identification code to a coupling list as a coupled terminal. Then, in order to register the WiFi phone 20 to be coupled, the phone screen 10 extracts the MAC address of the WiFi phone 20 from the second packet, and stores the extracted MAC address in a flash memory 16 (S130).

In this manner, the process of setting the identification codes for the coupling between the phone screen and the WiFi phone to thereby register the phone screen and WiFi phone as a coupled terminal is terminated.

Following step S130, the phone screen 10 sends a My-Ability packet (hereinafter, referred to as “third packet”) to the MAC address of the WiFi phone which is stored in the flash memory 16, wherein the third packet includes VoIP for a video call, namely video codec information of the phone screen (video codec capability) and IP information and media port information (media port number) (S134). Here, the video codec is configured of a video restoration algorithm capable of reproducing video data compressed on the basis of the VoIP. For this reason, when the video codec information is not set between the couple, it is impossible to reproduce a video RTP from the receiving video phone.

The WiFi phone 20 receives the third packet, and sends an acknowledging My-Ability-Ack packet (hereinafter, referred to as “fourth packet”) to the phone screen 10, wherein the fourth packet includes its own IP information and media port information for a video on the basis of the VoIP. Then, the WiFi phone 20 extracts the MAC address of the phone screen 10 from the third packet, stores the extracted MAC address of the phone screen 10 in an internal flash memory 27, and sets speech path information, i.e. the IP information and media port information (S181). Here, the MAC address of the phone screen 10, which is stored in the flash memory 27, is kept in reserve in order to restore the coupling when the coupling is intercepted due to external factors.

In this manner, the VoIP speech path for the audio-video communication between the phone screen 10 and the WiFi phone 20 is set to complete the coupling (S136). When the WiFi phone 20 attempts the coupling with the phone screen 10 through the AP, the coupling is based on the wired LAN. However, when the WiFi phone 20 attempts the coupling with the phone screen 10 without through the AP, the WiFi phone 20 can be coupled with the phone screen 10 on the basis of the wireless LAN.

Meanwhile, the plurality of WiFi phones 20 may be coupled with one phone screen 10 at the same time. However, for communication, only any one of the WiFi phones 20 opens the VoIP speech path to the phone screen 10, thereby being integrated into a coupling video phone to perform the audio-video communication with the receiving video phone.

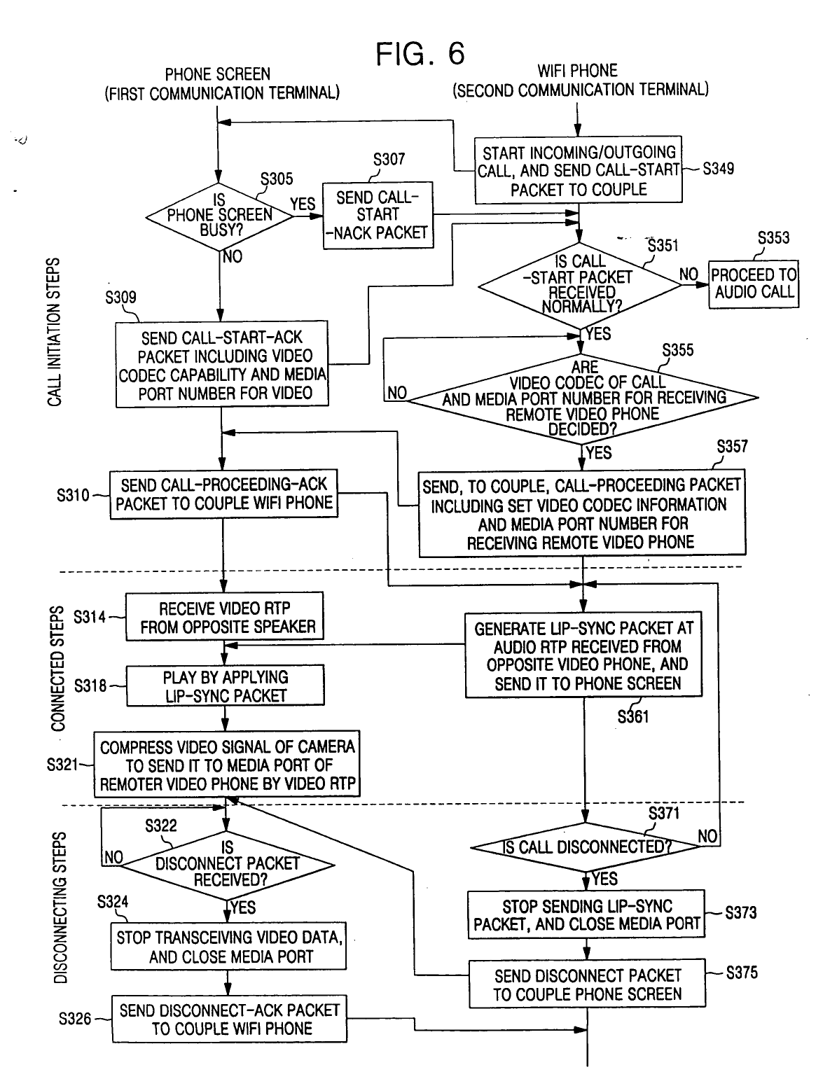

The coupling division communication method is as shown in FIG. 6, which is one of the methods where the phone screen and the WiFi phone are coupled to serve as the coupling video phone, and then communicate with the third communication terminal or receiving video phone, as mentioned above.

FIG. 6 is a flowchart where first and second communication terminals according to the present invention are coupled to perform audio-video communication with a third communication terminal by coupling division communication.

As to communication between coupling video phones 10 and 20 and a receiving video phone 30, the WiFi phone 20 sends a call connection packet to the other coupled terminal. The coupling video phone and the receiving video phone open a speech path to connect a call therebetween. After the call connection, video and audio communication is performed with the receiving video phone 30 through the speech path opened between a couple of a phone screen and a WiFi phone. After the video and audio communication, the speech path of the phone screen 10 is intercepted by a call disconnection packet of the WiFi phone. Thereby, the call is disconnected.

The speech path opening procedure for the call connection is as follows:

First, in a state where the phone screen 10 and the WiFi phone 20 are set as one coupling, when an outgoing or incoming call is generated at the WiFi phone 20, the WiFi phone 20 sends a Call Start packet (hereinafter, referred to as “call connection packet”) informing that call connection is initiated to the phone screen 10 so as to recognize the call generation (S349).

When receiving the call connection packet, the phone screen 10 recognizes that the WiFi phone 20 wants to perform audio-video communication with the receiving video phone 30, and thus determines whether or not a second receiving video phone is sending a video call (i.e., is on another line) in a state where the phone screen 10 is coupled currently with another WiFi phone (S305). If the second receiving video phone is on another line, the phone screen 10 sends a Call Start Nack packet to the WiFi phone 20 requesting the call in acknowledgement to the call connection packet, thereby informing that the phone screen 10 is on the line (S307). However, if the second receiving video phone is not on another line, the phone screen 10 encapsulates its own video codec information (video codec capability) and VoIP speech path information, namely its own IP information and media port information (media port number) in a Call Start Ack packet (hereinafter, referred to as “call connection acknowledgement packet”) in acknowledgement to the call connection packet, and sends it to the WiFi phone 20 requesting the call, thereby informing that video communication is possible (S309).

Then, the WiFi phone 20 checks whether the call connection acknowledgement packet is an acknowledgement packet to the call connection packet or not, thereby checking whether communication is possible or not (S351). If a non-acknowledgement packet is received or if the call connection acknowledgement packet is not received, the phone screen 10 can not be used or is in the video communication. Thus, the WiFi phone 20 performs communication only with an audio call according to its own audio codec information (audio codec capability) and VoIP speech path information, namely its own IP information and media port information (media port number) (S353). If the call connection acknowledgement packet is received, the WiFi phone 20 communicates with the receiving video phone 30 through a video call, and thus determines that the phone screen 10 can be used with regard to the call connection acknowledgement packet. Then, VoIP-based video codec information (video codec capability) as well as IP information and media port information (media port number) of the receiving video phone are determined as a speech path on the basis of the call connection acknowledgement packet (S355).

Thereafter, the WiFi phone 20 sends a Call Proceeding packet (hereinafter, referred to as “call processing packet) to the phone screen 10, wherein the call processing packet includes the VoIP-based video codec information (video codec capability) as well as IP information and media port information (media port number) of the receiving video phone that are determined as the speech path (S357). At this time, the phone screen 10 sends a call processing acknowledgement packet to the WiFi phone 20 in acknowledgement to the call processing packet (S310).

Video codec information (video codec capability) as well as corresponding IP information and media port information (media port number) of the phone screen are called a video speech path, and audio codec information (audio codec capability) as well as corresponding IP information and media port information (media port number) of the WiFi phone are called an audio speech path. The video and audio speech paths are generically called a VoIP speech path.

Then, the phone screen 10 and the WiFi phone 20 open the VoIP speech path required for video-audio communication to connect a call based on the video-audio communication with the receiving video phone.

The procedure of performing video-audio communication through the VoIP speech path is as follows:

In a state where the VoIP speech path is opened when the phone screen 10 and the WiFi phone 20 are coupled to perform coupling video-audio communication, video and audio calls from the receiving video phone 30 are connected at the phone screen 10 and WiFi phone 20 through a VoIP-based wired/wireless network, respectively.

When the VoIP speech path or media channel is opened, the phone screen 10 receives a video RTP packet for the video call of the receiving video phone 30 through a remote wired/wireless network (S314). At the same time, the WiFi phone 20 receives an audio RTP packet for the audio call of the receiving video phone 30 to generate a lip-sync packet including time stamp and sequence number of RTP for lip synchronization, and sends it to the phone screen 10 (S361). The lip-sync packet is a packet for synchronizing an audio with a mouth movement of a speaker of a video.

Then, the phone screen 10 reproduces the video RTP packet in synchronization with the lip-sync packet, so that the video call is lip-synched and displayed on the monitor 11. Simultaneously, a video signal picked up from the camera 12 of the phone screen 10 is compressed at a predetermined rate, and the resulting video RTP packet is sent through the media channel of the receiving video phone 30. Thus, user's video and audio are reproduced at the receiving video phone 30 (S321).

Therefore, video data of the receiving video phone 30 are directly transceived by the phone screen 10 and receiving video phone 30 on the basis of the VoIP, and audio data are directly transceived by the WiFi phone 20 and receiving video phone 30 on the basis of the VoIP. Because the WiFi phone 20 causes the packet for the lip-sync to be generated and sent to the phone screen 10, the synchronization of the video and audio calls is for synchronizing the video and audio on the same time axis.

Video RTP communication of the phone screen 10 is carried out with the receiving video phone 30 that is networked to the VoIP-based video speech path through the video channel by wire or wireless, and audio RTP communication of the WiFi phone 20 is carried out with the receiving video phone 30 that is networked to the VoIP-based audio speech path by wire or wireless. This is so designed that the WiFi phone 20 taking exclusive charge of a VoIP control signal delivers information on the media channels of the respective video and audio to the receiving video phone, and thereby the phone screen 10 and WiFi phone 20 take exclusive charge of video and audio parts to perform communication, respectively.

Taking SIP (Session Initiation Protocol) as an example, information for the media channel in the SIP is based on SDP (Session Description Protocol). To be specific, IP of an audio channel is designated as 165.213.87.101 which is IP of the WiFi phone 20, and a media port is designated as 49230, and an audio codec is designated as G.711 u-law (payload type 0). And, IP of a vedio channel is designated as 165.213.87.100 which is IP of the phone screen 10, and a media port is designated as 45000, and an audio codec is designated as H.261 (payload type 31) and Moving Picture Experts Group-MPEG (payload type 32).

The receiving video phone 30 communicates the audio RTP with the WiFi phone 20 through the IP and media port of the audio channel, and the video RTP with the phone screen 10 through the IP and media port of the video channel.

The procedure of terminating a call is as follows:

When a user wants to complete video and audio calls through the WiFi phone 20 and phone screen 10, he/she switches a whole call disconnection mode through the WiFi phone 20 to disconnect the whole call (S371). Then, the WiFi phone 20 stops transceiving media and lip-sync data to disconnect the speech path, namely the IP and media port (S373). A disconnect packet (hereinafter, referred to as “termination packet”) is sent to the phone screen 10 (S375).

The phone screen 10 continues to transceive an audio-video call until the termination packet is received. Then, when the termination packet is received (S322), the phone screen 10 stops transceiving video data with respect to the receiving video phone 30, and disconnects the speech path, namely the corresponding IP and media port (S324). Then, a Disconnect Ack packet (called “termination acknowledgement packet) returns to the WiFi phone 20 in acknowledgement to the termination packet. Thereby, the audio-video communication is terminated (S326).

As set forth above, the coupling division communication where the communication is performed on the audio and video signals using the speech path information, i.e. the IP and media information on the phone screen and WiFi phone has been described in detail.

However, the coupling integration communication of transceiving audio and video signals through one speech information, i.e. IP and media port information at the WiFi phone, and then sending and reproducing the video signal of them to the phone screen has a flow where all the procedures except the following procedures are performed in the same manner as the coupling division communication, and so a flowchart of the coupling integration communication is omitted.

In other words, each of the WiFi phone 20 and the phone screen 10 completes a coupling according to a coupling procedure, and has speech path information. One of the speech path information is IP and media port information of the WiFi phone 20 and the other is IP and media port information of the phone screen 10. Then, the WiFi phone 20 and the phone screen 10 are subjected to the speech path opening procedure for the call connection. The WiFi phone 20 completes the speech path opening procedure by sending its own speech path information to the receiving video phone that undergoes the call connection.

Then, the WiFi phone receives video and audio RTPs from the receiving video phone through its own speech path, sends the video RTP of them to the phone screen in real time, and at the same time sends a lip-sync packet together. The phone screen reproduces the video RTP on the basis of the lip-sync packet, and the WiFi phone reproduces the audio RTP received from the receiving video phone on the basis of the lip-sync packet.

Therefore, the receiving video phone can simultaneously send the video and audio RTP through one speech path directed to the WiFi phone, namely one IP and media port, thus receiving the video RTP of the phone screen through the speech path. Further, the WiFi phone sends and reproduces the video RTP and lip-sync packet to the phone screen while signaling and reproducing the audio RTP so that the user can hear it.

As discussed above, the audio-video communication between the coupling video phone and the receiving video phone according to the present invention is composed of the total of three steps, and causes the audio call based on the audio communication and the video call based on the video communication to be synchronized to makes integrated audio-video communication possible. Although the embodiment where the first and second communication terminals are adopted as the phone screen and WiFi phone respectively is described, this is equally true of an embodiment where as the phone screen 10 and IP phone 20′ respectively, as well as an embodiment where as the PC 10′ and IP phone 20′ respectively.

Meanwhile, in the procedure from setup of the coupling to the audio-video communication in the method of controlling the coupling between the communication terminals, except the coupling setup by the user's request, coupling restoration by power supply and coupling setup by video recognition may take place. The coupling restoration and setup are as follows:

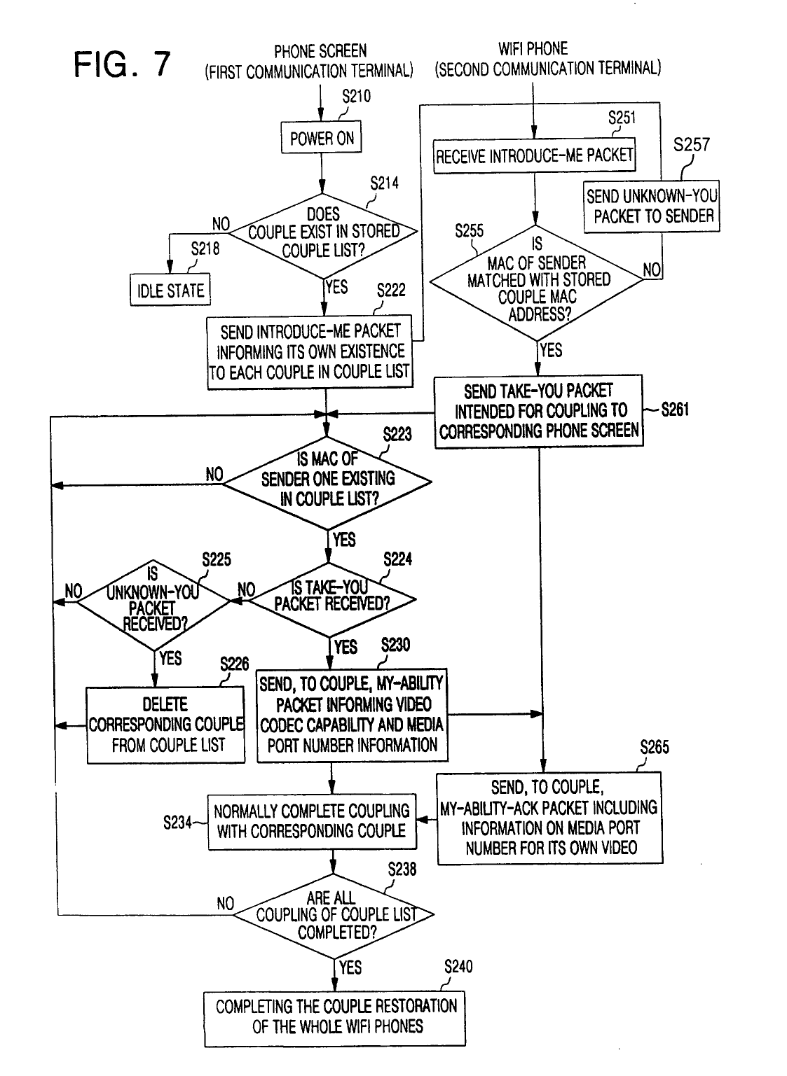

After a coupling is set up by the coupling restoration by power supply and coupling by video recognition is set up, first to third steps are sequentially performed for the audio-video communication between the coupling video phone and the receiving video phone as referred to FIG. 7. The restoration by the power supply is divided into one by power supply of the first communication terminal or phone screen and the other one by power supply of the second communication terminal or WiFi phone.

Therefore, in the method for controlling the coupling by the power supply of the phone screen 10 among from the first communication terminal or phone screen 10 and the second communication terminal or WiFi phone 20, the WiFi phone having an audio communication function is coupled with the phone screen having a video communication function in a started state, and starts the phone screen by supplying power to the phone screen again. Whether to be coupled with the WiFi phone is checked from the started phone screen, and then a coupling between them is restored.

And, in the restored state, communication between the coupling video phone and the receiving video phone processes a call by sequentially performing call connection, audio/video communication, and call disconnection between the coupling video phone and the receiving video phone or the other of the coupling.

For the coupling restoration by the power supply of the phone screen 10, the WiFi phone 20 having an audio communication function is coupled with the phone screen 10 having a video communication function in a started state, and starts the phone screen 10 by supplying power to the phone screen again. Whether to be coupled with the WiFi phone is checked from the started phone screen 10, and then a coupling between them is restored, which is as shown in FIG. 7.

FIG. 7 is a flowchart of restoring coupling between first and second communication terminals by power supply of the first communication terminal in accordance with the present invention.

The coupling restoration by the power supply of the phone screen 10 is initiated by supplying power to the phone screen 10 again in a state where the power is turned off (S210).

In other words, when a user drives the phone screen 10 by supplying it with power again, the phone screen 10 examines a coupling list stored in the flash memory 16, and then detects whether a listed coupled terminal exists in the coupling list or not (S214). After checking the existence of the coupled terminal, the phone screen 10 becomes in an idle state when the coupled terminal does not exist (S218). However, when the coupled terminal exists, the phone screen 10 unicasts an Introduce Me packet (hereinafter, referred to as “first packet”) that introduces itself to any one of the listed coupled terminal on the basis of a wired/wireless LAN (S222).

Each WiFi phone 20, second communication terminal corresponding to the coupling list, receives the first packet (S251), extracts a MAC address from the first packet, and determines whether or not the extracted MAC address is matched with that of the coupled terminal stored in itself (S255). In other words, the WiFi phone 20 determines whether or not the MAC address a sender extracted from the first packet is matched with that of the coupled terminal stored in its own flash memory 27.

If not matched, the WiFi phone 20 sends an Unknown You packet to the sender, phone screen 10, in acknowledgement to it (S257). If matched, the WiFi phone 20 sends a Take You packet (hereinafter, referred to as “second packet”) having a message for coupling the sender, phone screen 10, in acknowledgement to it (S261). For example, the WiFi phone 20 sends the second packet for reminding a previously coupled fact to the phone screen 10, and prepares the coupling restoration.

Then, the phone screen 10 receives the second packet, extracts a MAC address from the second packet, and determines whether or not the extracted MAC address is matched with that of the first packet (S223). Thus, the phone screen 10 determines whether the second packet, normal Take You packet, is received or not (S224).

If the second packet is not received, the phone screen 10 determines whether or not the Unknown You packet is received from the WiFi phone 20, which is repeated until the second packet is received (S225). Consequently, if the Unknown You packet is not received, the phone screen 10 recognizes that the coupling is cancelled or not properly set up, and so deletes the WiFi phone from the coupling list (S226).

If the second packet is received, the phone screen 10 sends a My-Ability packet (hereinafter, referred to as “third packet”) to the MAC address of the WiFi phone 20 which is stored in the flash memory 16, wherein the third packet includes VoIP for a video call, namely video codec information of the phone screen (video codec capability) and IP information and media port information (media port number) (S230). Here, the video codec is configured of a video restoration algorithm capable of reproducing video data compressed on the basis of the VoIP. For this reason, when the video codec information is not set between the phone screen 10 and WiFi phone 20 of coupling video phone, it is impossible to reproduce a video RTP from the receiving video phone.

The WiFi phone 20 receives the third packet, and sends an acknowledging My-Ability-Ack packet (hereinafter, referred to as “fourth packet”) to the phone screen 10 to restore the coupled terminal (S265), wherein the fourth packet includes its own IP information and media port information for a video on the basis of the VoIP. Then, the WiFi phone 20 extracts the MAC address of the phone screen 10 from the third packet, stores the extracted MAC address of the phone screen 10 in an internal flash memory 27, and sets information on the speech path.

Then, the phone screen 10 receives the fourth packet to be normally set as the coupling for the corresponding coupled terminal, and thus completes the restoration (S234).

In this manner, after completing the coupling restoration with one WiFi phone, the phone screen determines whether or not other coupled terminals recorded in the coupling list exist (S238). The phone screen repeatedly performs this process until the coupling restoration is completed, and thereby completing the coupling restoration of the whole WiFi phones (S240).

After the coupling restoration is completed by supplying power to the phone screen as mentioned above, video and audio calls can be transceived between the couple of the phone screen and the WiFi phone, namely between the coupling video phone and the receiving video phone. In the audio-video communication method, the audio-video communication is performed in the above-mentioned method.

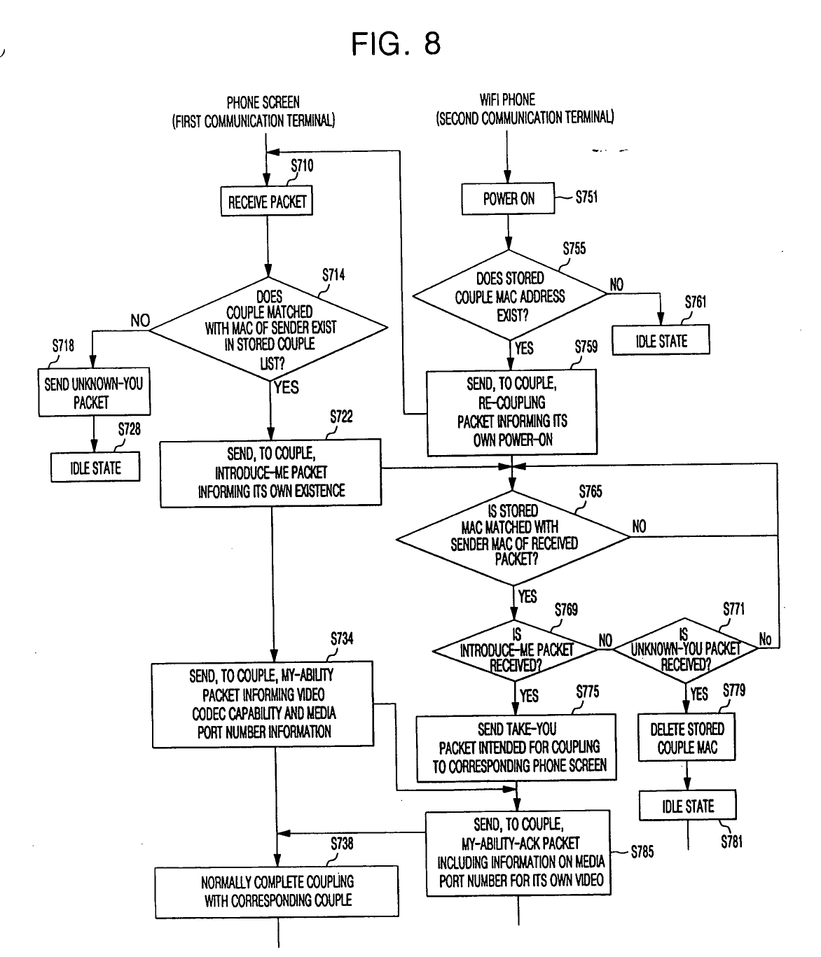

For the coupling restoration by power supply of the WiFi phone 20, the WiFi phone 20 having an audio communication function is coupled with the phone screen 10 having a video communication function in a started state, and starts the phone screen 10 by supplying power to the WiFi phone 20 again. Whether to be coupled with the WiFi phone 20 is checked from the started phone screen 10, and then a coupling between them is restored, which is as shown in FIG. 8.

FIG. 8 is a flowchart of restoring coupling between first and second communication terminals by power supply of the second communication terminal in accordance with the present invention.

The coupling restoration by the power supply of the WiFi phone 20 is initiated by supplying power to the WiFi phone 20 again in a state where the power is turned off (S751).

In other words, when a user drives the WiFi phone 20 by supplying it with power again, the WiFi phone 20 determines whether a MAC address of the coupled terminal stored in the flash memory 27 exists or not (S755). After checking the existence of the MAC address of the coupled terminal, the WiFi phone 20 becomes in an idle state when the MAC address of the coupled terminal does not exist (S761). However, when the MAC address of the coupled terminal exists, the WiFi phone 20 sends a Re-Coupling packet (hereinafter, referred to as “first packet”) that informs a driving state to the phone screen, coupled terminal of the WiFi phone 20 (S759).

The phone screen 10 receives the first packet (S710), extracts a MAC address of the WiFi phone 20, sender, from the first packet, and determines whether to be matched with the coupled terminal registered with its own coupling list (S714). If not matched, the phone screen 10 sends an Unknown You packet to the sender (S718), and enters to the idle state (S728). If matched, the phone screen 10 sends an Introduce Me packet (hereinafter, referred to as “second packet”) to the coupling, sender, in acknowledgement to the first packet (S722).

Then, the WiFi phone 20 receives the second packet, extracts the MAC address of the phone screen 10 from the second packet, and determines whether or not the extracted MAC address is matched with that of the first packet (S765). Thus, the WiFi phone 20 determines whether the normal Introduce Me packet, second packet, is received or not (S769).

If the second packet is not received, the WiFi phone 20 determines whether or not the Unknown You packet is received from the phone screen 10, which is repeated until the second packet is received (S771). Consequently, if the Unknown You packet is not received, the WiFi phone recognizes that the coupling is cancelled or not properly set up, and thus deletes the coupling MAC address of the phone screen on the coupling list (S779). Then, the WiFi phone itself becomes in the idle state (S781).

If the second packet is received, the WiFi phone 20 sends a Take You packet (hereinafter, referred to as “third packet”) having intention of restoring the coupling with the phone screen 10 to the phone screen 10 (S775).

The phone screen 10 sends a My-Ability packet (hereinafter, referred to as “fourth packet”) to the MAC address of the phone screen 10 which is stored in the flash memory 16, wherein the fourth packet includes VoIP for a video call, namely its own video codec information (video codec capability) and IP information and media port information (media port number) (S734). Here, the video codec is configured of a video restoration algorithm capable of reproducing video data compressed on the basis of the VoIP. For this reason, when the video codec information is not set between the couple, it is impossible to reproduce a video RTP from the receiving video phone.

The WiFi phone 20 receives the fourth packet, and sends an acknowledging My-Ability-Ack packet (hereinafter, referred to as “fifth packet”) to the phone screen 10 to restore the coupling (S785), wherein the fifth packet includes its own IP information and media port information for a video on the basis of the VoIP. Then, the WiFi phone 20 extracts the MAC address of the phone screen 10 from the fourth packet, stores the extracted MAC address of the phone screen 10 in the internal flash memory 27, and sets information on the speech path.

Then, the phone screen 10 receives the fifth packet to be normally set as the coupling for the corresponding coupled terminal, and thus completes the restoration (S738).

After the coupling restoration is completed by supplying power to the WiFi phone as mentioned above, video and audio calls can be transceived between the couple of the phone screen and the WiFi phone, namely between the coupling video phone and the receiving video phone. In the audio-video communication method, the audio-video communication is performed in the above-mentioned method.

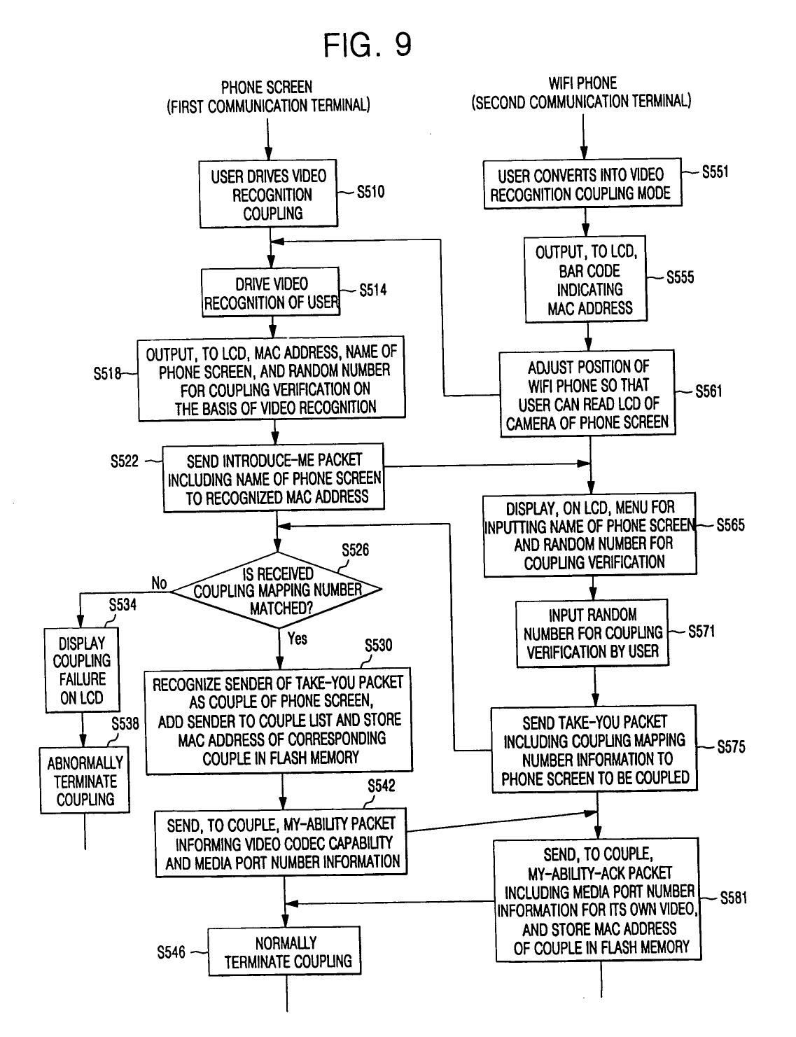

Meanwhile, in addition to the coupling by the user, the coupling by video recognition of the phone screen such as the first communication terminal is set up in such a manner that the phone screen having the video communication function sets up the video recognition coupling mode for itself, and that the WiFi phone having the audio communication function sets up the video recognition coupling mode for itself The phone screen reads a recognition code where its own MAC address is coded on the LCD window of the WiFi phone, and thus both the coupling information and the speech path information are set between the phone screen and the WiFi phone to set up the coupling, which is as shown in FIG. 9.

FIG. 9 is a flowchart of carrying out coupling between first and second communication terminals by means of an identification code of the first communication terminal in accordance with the present invention. Audio-video communication will be omitted because it is similar to the foregoing after the coupling restoration.

Setup of coupling based on video recognition of the phone screen such as the first communication terminal starts the coupling by a user manipulating the WiFi phone 20 to switch it into coupling mode by a bar code for the video recognition (S551).

The WiFi phone 20 switched into the coupling mode soft-outputs the bar code for the video recognition for the coupling to a LCD type monitor (S555). At this time, the user gets the monitor 22 on which the bar code is displayed to approach the camera 12 of the phone screen 10, and then adjusts the camera 12 to scan the bar code of the monitor 22 (S561).

At the same time, the user switches and drives the coupling mode so that the coupling mode for the video recognition is performed on the phone screen 10 (S510). Then, the bar code for the video recognition of the WiFi phone 20 which approaches the camera 12 of the phone screen 10 is scanned (S514).

Then, the phone screen 10 generates a MAC address of the WiFi phone 20 which is recognized by analyzing the scanned bar code, and displays its own monitor an identification code of its own name and a coupling identification code (random number) for coupling verification (S518). The phone screen 10 unicasts an Introduce Me packet (hereinafter, referred to as “first packet”) having the name identification code and the coupling identification code through the recognized MAC address (S522). The WiFi phone 20 receives the first packet including the identification codes with an equipment environment set in the coupling mode, displays it on the LCD window, i.e. menu screen of the monitor, and informs the user of it (S565).

The user checks and selects the name of the phone screen 10 which is displayed on the menu screen of the monitor 22 of the WiFi phone 20, and thus the WiFi phone 20 requests the user to input the coupling identification code (random number) for the coupling verification. At this time, the user inputs the coupling identification code, namely the random number, which is sent together with the name of the phone screen 10 (S571).

Then, the WiFi phone 20 sends a Take You packet (hereinafter, referred to as “second packet”) including the coupling identification code (random number for the coupling verification) back to the phone screen 10 (S575). At this time, in addition to the coupling identification code, the MAC address of the WiFi phone 20 is recorded in the second packet, so that it can be extracted.

After receiving the coupling identification code of the second packet, the phone screen 10 determines whether or not the identification code of the second packet is matched with that of the first packet that the phone screen 10 has sent (S526). As a result of determining, if the identification codes are matched with each other, the phone screen 10 recognizes the WiFi phone 20, sender, to add the identification code to a coupling list as a coupled terminal. Then, in order to extract the MAC address from the second packet to register the coupled WiFi phone 20, phone screen 10 stores the MAC address in the flash memory 16 (S530). However, if not, a message of coupling failure is displayed on the monitor of the phone screen 10 (S534). The coupling is abnormally terminated (S538).

In this manner, the process of setting the coupling identification code based on the video recognition mode between the phone screen 10 and the WiFi phone 20 to register it as the coupling is terminated.

Following step S530, the phone screen 10 sends a My-Ability packet(hereinafter, referred to as “third packet”) to the MAC address of the WiFi phone 20 which is stored in the flash memory 16, wherein the third packet includes VoIP for a video call, namely its own video codec information (video codec capability) and IP information and media port information (media port number) (S542). Here, the video codec is configured of a video restoration algorithm capable of reproducing video data compressed on the basis of the VoIP. For this reason, when the video codec information is not set between the couple, it is impossible to reproduce a video RTP from the receiving video phone.

The WiFi phone 20 receives the third packet, and sends an acknowledging My-Ability-Ack packet (hereinafter, referred to as “fourth packet”) to the phone screen 10 to restore the coupling (S265), wherein the fourth packet includes its own IP information and media port information for a video on the basis of the VoIP. Then, the WiFi phone 20 extracts the MAC address of the phone screen 10 from the third packet, stores the extracted MAC address of the phone screen 10 in the internal flash memory 27, and sets information on the speech path. Here, the MAC address of the phone screen 10, which is stored in the flash memory 27, is kept in reserve in order to restore the coupling when the coupling is intercepted due to external factors.

In this manner, the VoIP speech path for the audio-video communication between the phone screen 10 or first communication terminal and the WiFi phone 20 or second communication terminal is set to complete the coupling (S546). This is performed on the basis of the wired and wireless LAN.

A plurality of WiFi phones 20 maybe coupled with one phone screen 10 at the same time. However, for communication, only one of the WiFi phones 20 opens the VoIP speech path to the phone screen 10, thereby being integrated into a coupling video phone to perform the audio-video communication with the receiving video phone. In other words, as mentioned in FIG. 7, the first, second and third steps are sequentially performed to transceiver the video and audio calls with respect to the receiving video phone.

According to the present invention, the plurality of WiFi phones are each coupled with one phone screen by predetermined rules, and thereby any one of the WiFi phones can be used as an individual video phone. As such, a degree of application of the phone screen can be improved, and expensive devices mounted in the phone screen can be saved by the number of the coupled WiFi phones.

Further, the plurality of WiFi phones are each coupled with one phone screen by constant rules at the same time, and thereby one phone screen can perform one-to-one communication with the WiFi phone intended for communication. Therefore, the corresponding WiFi phone can make exclusive of the phone screen, and thus it is possible to improve convenience of the user of the WiFi phone.

Although exemplary embodiments of the present invention have been described, it will be understood by those skilled in the art that the present invention should not be limited to the described exemplary embodiments. Rather, various changes and modifications can be made within the spirit and scope of the present invention, as defined by the following claims.

What is claimed is:

1. A system for controlling coupling between communication terminals for audio-video communication with a third communication terminal having video and audio communication functions, the system comprising:
a first communication terminal that performs reciprocal recognition with a second communication terminal on the basis of a wired and wireless local area network (LAN), establishes a first speech path for video communication with the third communication terminal to set up a coupling with the second communication terminal, and performs video communication with the third communication terminal using the first speech path; and
a second communication terminal that performs reciprocal recognition with a first communication terminal on the basis of the wired and wireless LAN, establishes a second speech path for audio communication with the third communication terminal to set up a coupling, performs audio communication with the third communication terminal using the second speech path, and sends a lip-sync packet to the first communication terminal.

2. The system of claim 1, wherein the first communication terminal includes:
an Ethernet interface that interfaces with the second communication terminal on the basis of the wired and wireless LAN to transceive coupling information for setting up the coupling, and performs video real time protocol (RTP) communication with the third communication terminal through the first speech path;
a video codec that performs signaling on compression data of a video RTP to be displayed on a monitor and compresses a video signal of a camera at a predetermined rate of compression;
a flash memory that stores the coupling information and information on the first speech path for establishing the first speech path; and
a central processing unit (CPU) that controls the Ethernet interface, the video codec and the flash memory so as to enable the coupling with the second communication terminal and the communication with the third communication terminal.

3. The system of claim 1, wherein the second communication terminal includes:
a wireless local area network (WLAN) that interfaces with the first communication terminal on the basis of the wired and wireless LAN to transceive coupling information for setting up the coupling, and performs audio real time protocol (RTP) communication with the third communication terminal through the second speech path;
an audio codec that reproducibly performs audio signaling on an audio RTP to be audibly heard at a handset, and coverts an audio signal of the handset into an RTP signal;
a flash memory that stores the coupling information and information on the second speech path for establishing the second speech path; and
a central processing unit (CPU) that controls the WLAN, the video codec and the flash memory so as to enable the coupling with the second communication terminal and the communication with the third communication terminal,
wherein the WLAN connects the first communication terminal with the third communication terminal on the basis of a wired LAN via an access point (AP) when the WLAN is a wireless network.

4. The system of claim 1, wherein:
the first speech path information includes IP information of the first communication terminal for transceiving the video signal, and media port and codec information for transceiving the video signal;
the second speech path information includes IP information of the second communication terminal for transceiving the audio signal, and media port and codec information for transceiving the audio signal; and
the coupling information includes an identification code for recognizing reciprocal coupling between the first communication terminal and the second communication terminal, and an identification code of the first communication terminal.

5. The system of claim 1, wherein the first communication terminal is any one of a phone screen having a wireless video communication function, and a personal computer (PC) having a wireless video communication function; and the second communication terminal is a short-distance wireless communication terminal having a wireless audio communication function.

6. A system for controlling coupling between communication terminals for audio-video communication with a third communication terminal having video and audio communication functions, the system comprising:
a first communication terminal that performs reciprocal recognition with a second communication terminal on the basis of a wired and wireless local area network (LAN), establishes a first speech path for the video communication with the second communication terminal to set up a coupling, and performs communication of video signal and lip-sync packet from the second communication terminal through the first speech path; and
a second communication terminal that performs reciprocal recognition with a first communication terminal on the basis of the wired and wireless LAN, establishes a second speech path for audio-video communication with the third communication terminal to set up a coupling, performs any one of video communication and audio communication with the third communication terminal using the second speech path, and selectively performs communication of video signal and lip-sync packet on the first communication terminal.

7. A method for controlling coupling between communication terminals for audio-video communication, the method comprising the steps of:
setting up, by a first communication terminal having a video communication function and a second communication terminal having an audio communication function, a coupling mode therebetween; and
checking a coupling between the first communication terminal and the second communication terminal by means of a coupling identification code, and setting a speech path for transceiving video data to set up the coupling.

8. The method of claim 7, wherein the step of setting up the coupling includes the steps of:
broadcasting a first packet to the second communication terminal, the first packet having an identification code of the first communication terminal and the coupling identification code of the second communication terminal corresponding to the identification code;
sending, by the second communication terminal receiving the first packet, the coupling identification code and a second packet to the first communication terminal to check a coupled terminal, the second packet having a media access control (MAC) address of the second communication terminal;
determining whether or not the coupling identification code of the second packet sent from the second communication terminal is matched with that of the first packet broadcast from the first communication terminal;
recognizing the second communication terminal as the coupled terminal of the first communication terminal to add the second communication terminal to a coupling list on the basis of the determining, and storing the MAC address of the second communication terminal in a memory of the first communication terminal;
sending a third packet having information on the speech path of the first communication terminal to the second communication terminal after the MAC address is stored; and
storing an MAC address of the third packet in a memory of the second communication terminal, and sending a fourth packet for acknowledging the third packet to the first communication terminal to complete the coupling.

9. The method of claim 7, further comprising the step of processing at least one of video and audio calls between the coupled terminal and the other party, the third communication terminal, on the basis of the speech path information.

10. The method of claim 9, wherein the step of processing at least one of video and audio calls includes the steps of:
generating, at the second communication terminal, a Call Start packet to the first communication terminal;
determining, at the first communication terminal, whether the speech path is in use or not;
sending a Call Start Nack packet to the second communication terminal when the speech path is in use, and sending a Call Start Ack packet to the second communication terminal when the speech path is not in use;
establishing, by the second communication terminal itself, the speech path based on information on the speech path, sending a call processing packet having the speech path information to the first communication terminal, and opening the speech path by returning the call processing packet to the second communication terminal;
receiving an audio real time protocol (RTP) from the third communication terminal on the basis of a VoIP-based audio speech path, generating a lip-sync packet from the audio RTP, and sending the lip-sync packet to the first communication terminal;
receiving a video RTP from the third communication terminal on the basis of a VoIP-based video speech path and displaying the video RTP by interworking with the lip-sync packet;
sending, to the third communication terminal, the video RTP compressing a video signal from a camera of the first communication terminal and the audio RTP compressing an audio signal from the second communication terminal through the corresponding speech paths;
repeating the steps until a call disconnect message is received from the second communication terminal;
stopping transmission of the lip-sync packet according to an instruction of disconnecting the call generated from the second communication terminal, closing the corresponding speech path to send a call termination packet to the first communication terminal; and
stopping transmission of the video packet according to the call termination packet, closing the speech path to send an acknowledgement packet of the call termination packet to the second communication terminal.

11. A method for controlling coupling between communication terminals for audio-video communication, the method comprising the steps of:
while a second communication terminal having an audio communication function is coupled with a first communication terminal having a video communication function in a started state, starting the first communication terminal by supplying the first communication terminal with power again; and
checking from the first communication terminal started in the step of starting whether to be coupled with the second communication terminal, and restoring a coupling between the first and second communication terminals.

12. The method of claim 11, wherein the step of restoring the coupling includes the steps of:
broadcasting a first packet having an identification code of the first communication terminal to the second communication terminal;
extracting a media access control (MAC) address of the first communication terminal from the first packet, checking whether or not the extracted MAC address is matched with that stored in the second communication terminal, and sending a second packet for coupling acknowledgment to the first communication terminal;
extracting an MAC address of a sender from the second packet, checking setting according to whether or not the extracted MAC address is matched with that recorded in a coupling list of the first communication terminal;
sending a third packet having speech path information of the first communication terminal to the sender after the second packet is received; and
sending a fourth packet for acknowledging the third packet to the first communication terminal to complete the coupling.

13. The method of claim 12, further comprising the step of: when another second communication terminal exists in the coupling list, repeating the steps of checking setting of the MAC address and restoring the coupling.

14. The method of claim 11, further comprising the step of processing at least one of video and audio calls between a coupled terminal and the other party, the third communication terminal, on the basis of restored speech path information.

15. A method for controlling coupling between communication terminals for audio-video communication, the method comprising the steps of:
while a first communication terminal having a video communication function is coupled with a second communication terminal having an audio communication function in a started state, starting the second communication terminal by supplying the second communication terminal with power again; and
checking from the second communication terminal started in the step of starting whether to be coupled with the first communication terminal, and restoring a coupling between the first and second communication terminals.

16. The method of claim 15, wherein the step of restoring the coupling includes the steps of:
checking that a media access control (MAC) address of the first communication terminal is stored in the second communication terminal, and sending a first packet, Re-coupling packet, for restoring a disconnected coupling to the first communication terminal;
receiving the first packet, checking that the same MAC address as that of the second communication terminal or sender is stored in the coupling list of the first communication terminal, and sending a second packet, Introduce-Me packet, to the second communication terminal, the second packet having an identification code of the first communication terminal;
extracting the MAC address of the second communication terminal or sender from the second packet of the first communication terminal, checking whether or not the extracted MAC address is identical to that of the second communication terminal, sending a third packet requesting the coupling to the first communication terminal;
sending a fourth packet to the sender after the third packet is received, the fourth packet having speech path information of the first communication terminal; and
sending a fifth packet for acknowledging the fourth packet to the first communication terminal and restoring the coupling.

17. The method of claim 15, further comprising the step of processing a call by sequentially performing call connection, audio/video communication, and call disconnection between a coupled terminal and the other party, the third communication terminal, on the basis of restored speech path information.

18. A method for controlling coupling between communication terminals for audio-video communication, the method comprising the steps of:
setting up, by a first communication terminal having a video communication function itself, a video recognition coupling mode, and setting up, by a second communication terminal having an audio communication function itself, the video recognition coupling mode; and
reading, by the first communication terminal, a recognition code where a media access control (MAC) address of the second communication terminal is coded at a liquid crystal display (LCD) window of the second communication terminal, and thus setting coupling and speech path information between the first communication terminal and the second communication terminal to set up a coupling.

19. The method of claim 18, wherein the step of setting up the coupling includes the steps of:
sending a first packet, Introduce-Me packet, through the MAC address of the second communication terminal, the first packet having identification code of the first communication terminal and coupling identification code;
sending, by the second communication terminal receiving the first packet, a second packet to the first communication terminal, the second packet having the coupling identification code and the MAC address of the second communication terminal;
determining whether or not the coupling identification code of the second packet is matched with that of the first packet sent from the first communication terminal;
recognizing a sender of the first communication terminal as a coupled terminal of the first communication terminal on the basis of the determining, adding the sender to a coupling list, and storing the MAC address of the second communication terminal in a memory of the first communication terminal;
sending a third packet to the sender after the MAC address is stored, the third packet having the speech path information of the first communication terminal; and
storing the MAC address of the first communication terminal in a memory of the sender from the third packet, and sending a fourth packet for acknowledging the third packet to the first communication terminal to complete the coupling.

20. The method of claim 18, further comprising the step of processing at least one of video and audio calls between the coupled terminal and the other party, the third communication terminal, on the basis of set speech path information.
